(19) United States
(12) Patent Application Publication
(10) Pub. No.: US 2011/0221967 A1
(43) Pub. Date: Sep. 15, 2011

(54) MOTION VECTOR MEASUREMENT DEVICE AND METHOD

(76) Inventor: Makoto YONAHA, Kanagawa-ken (JP)

(21) Appl. No.: 13/009,408

(22) Filed: Jan. 19, 2011

(30) Foreign Application Priority Data
Mar. 15, 2010 (JP) 056972/2010

(51) Int. Cl. H04N 5/14

(52) U.S. Cl. 348/699; 348/E05.065

(57) ABSTRACT

A motion vector at an object pixel position in an object frame in a moving image is measured based on the object frame and a previous frame. At this time, for each object pixel in the object frame, a motion-vector distribution in a motion-vector detection space defined by a predetermined number of pixels is calculated by calculating scores, each representing a correlation between the object pixel and a pixel in the previous frame corresponding to the object pixel, with shifting the previous frame relative to the object frame in a range of the predetermined number of pixels. Then, a motion vector at the object pixel is detected based on differences between the score at the center position in the motion-vector detection space and the scores at positions other than the center position, and whether or not the motion vector is erroneously measured is determined based on the motion-vector distribution.

### BACKGROUND OF THE INVENTION

1. Field of the Invention

The present invention relates to a motion vector measurement device and a motion vector measurement method for measuring a motion vector representing motion of an object in a moving image, as well as a program for causing a computer to carry out the motion vector measurement method.

2. Description of the Related Art

As a technique to measure a motion vector in an image, a block matching process based on correlation operation has conventionally been known. The block matching process involves dividing an object frame, which is an object of the motion vector measurement, into blocks of an appropriate size (for example, 8×8 pixels), calculating differences between pixels in the object frame and pixels in a previous frame for each block, and finding pixel positions in the previous frame that provide the minimum sum of absolute values of the differences. In the block matching process, a difference between positions of corresponding blocks in the object frame and the previous frame indicates a motion vector for the pixel position at the center of the block in the object frame.

Further, a technique used in measurement of a motion vector using the block matching process has been proposed, which involves calculating a plurality of motion vectors in a predetermined search range in an object frame, and selecting one of the motion vectors that has the smallest evaluation value of the motion vector (see Japanese Unexamined Patent Publication No. 2006-101239, which will hereinafter be referred to as Patent Document 1). Still further, a technique which involves generating a motion vector distribution for a block of interest and surrounding blocks between an object frame and a previous frame, and selecting an optimal motion vector from a plurality of motion vectors contained in the motion vector distribution has been proposed (see Japanese Unexamined Patent Publication No. 9 (1997)-037270, which will hereinafter be referred to as Patent Document 2). According to the techniques disclosed in Patent Documents 1 and 2, accurate detection of the motion vector can be achieved.

In the techniques disclosed in the above-mentioned Patent Documents 1 and 2, however, the motion vector is calculated using a relatively large block, such as a block of 8×8 pixels, and therefore a large amount of operation is required for the calculation of the motion vector, which in turn requires a long time for the calculation of the motion vector. To address this problem, it may be considered to use a smaller-size block in the block matching process. However, using a smaller-size block may often lead to erroneous measurement, such as the case where a motion vector is detected when there actually is no motion or the detected motion vector is instable. Further, in the technique disclosed in the above-mentioned Patent Document 2, the motion vector distribution for blocks around the block of interest is used. Since this motion vector distribution is not formed by a motion vector of the block of interest, this technique cannot provide highly accurate detection of the motion vector.

### SUMMARY OF THE INVENTION

In view of the above-described circumstances, the present invention is directed to providing highly accurate measurement of a motion vector with a low amount of operation.

An aspect of the motion vector measurement device according to the invention is a motion vector measurement device for measuring a motion vector at an object pixel position in an object frame among a plurality of frames contained in a moving image based on the object frame and a previous frame apart from the object frame by a predetermined frame distance in the moving image, the device including:

motion vector distribution calculating means for calculating, for each object pixel to be an object of the motion vector measurement in the object frame, a motion vector distribution in a motion vector detection space defined by a predetermined number of pixels by calculating scores, each representing a correlation between the object pixel and a corresponding pixel in the previous frame corresponding to the object pixel, with shifting the previous frame relative to the object frame in a range of the predetermined number of pixels;

motion vector detecting means for detecting a motion vector at the object pixel based on differences between the score at a center position in the motion vector detection space for the motion vector distribution and the scores at positions other than the center position in the motion vector detection space; and

erroneous measurement determining means for determining whether or not the motion vector is erroneously measured based on the motion vector distribution.

The motion vector measurement device according to the invention may further include averaging means for averaging the motion vector distribution.

In the motion vector measurement device according to the invention, the motion vector distribution calculating means may calculate the scores which are normalized based on pixel values of pixels in a block having a predetermined size with the object pixel at a center of the block.

In the motion vector measurement device according to the invention, the erroneous measurement determining means may determine that the motion vector is erroneously measured if a difference between the score at a starting point position and the score at an end point position of the motion vector in the motion vector detection space is smaller than a predetermined threshold value.

The motion vector measurement device according to the invention may further include: second motion vector distribution calculating means for calculating, for each object pixel, a second motion vector distribution in the motion vector detection space by calculating scores, each representing a correlation between the object pixel and a corresponding pixel in the previous frame corresponding to the object pixel, with shifting the object frame relative to the previous frame in the range of the predetermined number of pixels; and

second motion vector detecting means for detecting a second motion vector at the object pixel based on differences between the score at a center position in the motion vector detection space for the second motion vector distribution and the scores at positions other than the center position in the motion vector detection space for the second motion vector distribution,

wherein the erroneous measurement determining means determines that the motion vector is not erroneously measured if the motion vector and the second motion vector have the same magnitude and directions of the motion vector and the second motion vector are opposite from each other.

The motion vector measurement device according to the invention may further include: self-motion vector distribution calculating means for calculating, for each object pixel, a self-motion vector distribution in the motion vector detection space by calculating, with shifting a duplication of the object frame relative to the object frame in the range of the predetermined number of pixels, scores each representing a correlation between the object pixel and a corresponding pixel in the duplication of the object frame corresponding to the object pixel,

wherein, in a case where the score is larger when the correlation is higher, the erroneous measurement determining means compares the score in the motion vector detection space for the self-motion vector distribution at a position corresponding to the end point position of the motion vector in the motion vector detection space with a predetermined threshold value, and determines that the motion vector is erroneously measured if the score is not smaller than the predetermined threshold value.

It should be noted that, in a case where the score is smaller when the correlation is higher, the erroneous measurement determining means determines that the motion vector is erroneously measured if the score is smaller than the predetermined threshold value.

In the motion vector measurement device according to the invention, the erroneous measurement determining means may determine whether or not the motion vector is erroneously measured with using a classifier generated through a machine learning process for determining whether or not the motion vector is a true motion vector.

An aspect of the motion vector measurement method according to the invention is a motion vector measurement method of measuring a motion vector at an object pixel position in an object frame among a plurality of frames contained in a moving image based on the object frame and a previous frame apart from the object frame by a predetermined frame distance in the moving image, the method including:

calculating, for each object pixel to be an object of the motion vector measurement in the object frame, a motion vector distribution in a motion vector detection space defined by a predetermined number of pixels by calculating scores, each representing a correlation between the object pixel and a corresponding pixel in the previous frame corresponding to the object pixel, with shifting the previous frame relative to the object frame in a range of the predetermined number of pixels;

detecting a motion vector at the object pixel based on differences between the score at a center position in the motion vector detection space for the motion vector distribution and the scores at positions other than the center position in the motion vector detection space; and

determining whether or not the motion vector is erroneously measured based on the motion vector distribution.

The motion vector measurement method according to the invention may be provided in the form of a program for causing a computer to carry out the motion vector measurement method.

According to the invention, a motion vector at each object pixel is detected based on values of the scores in the motion vector distribution, and determination is made as to whether or not the motion vector is erroneously measured based on the detected motion vector. Therefore, even when a block having a small size is used for measuring the motion vector using the block matching process, an erroneously measured motion vector can be determined, thereby achieving accurate measurement of the motion vector. Further, use of a small block is allowed, the amount of operation can be reduced, thereby achieving high speed measurement of the motion vector.

Further, by averaging the motion vector distribution, noise removal from the motion vector distribution D is achieved, thereby achieving more accurate measurement of the motion vector.

Still further, by calculating the normalized scores, erroneous detection of the motion vector due to fluctuation of the exposure value and unexpected lightness change while the moving image is taken can be prevented, thereby achieving more accurate measurement of the motion vector.

### BRIEF DESCRIPTION OF THE DRAWINGS

FIG. 1 is a schematic block diagram illustrating the configuration of a motion vector measurement device according to a first embodiment of the present invention,

FIG. 2 is a diagram for explaining an operation carried out by a hierarchization unit,

FIG. 3 is a schematic block diagram illustrating the configuration of a motion vector measuring unit in the first embodiment,

FIG. 4 is a diagram for explaining calculation of a motion vector distribution,

FIG. 5 is a diagram for explaining reconstruction of a motion vector,

FIG. 6 is a diagram for explaining reconstruction of the motion vector,

FIG. 7 is a diagram for explaining detection of a motion vector,

FIG. 8 is a flow chart illustrating a process carried out in the first embodiment,

FIG. 9 is a schematic block diagram illustrating the configuration of a motion vector measuring unit in a second embodiment,

FIG. 10 is a diagram for explaining measurement of a second motion vector,

FIG. 11 is a schematic block diagram illustrating the configuration of a motion vector measuring unit in a third embodiment,

FIG. 12 is a diagram for explaining calculation of a self-motion vector distribution, and

FIG. 13 is a diagram showing a state where scores of the self-motion vector distribution are assigned to a motion vector detection space for an object pixel position.

### DESCRIPTION OF THE PREFERRED EMBODIMENTS

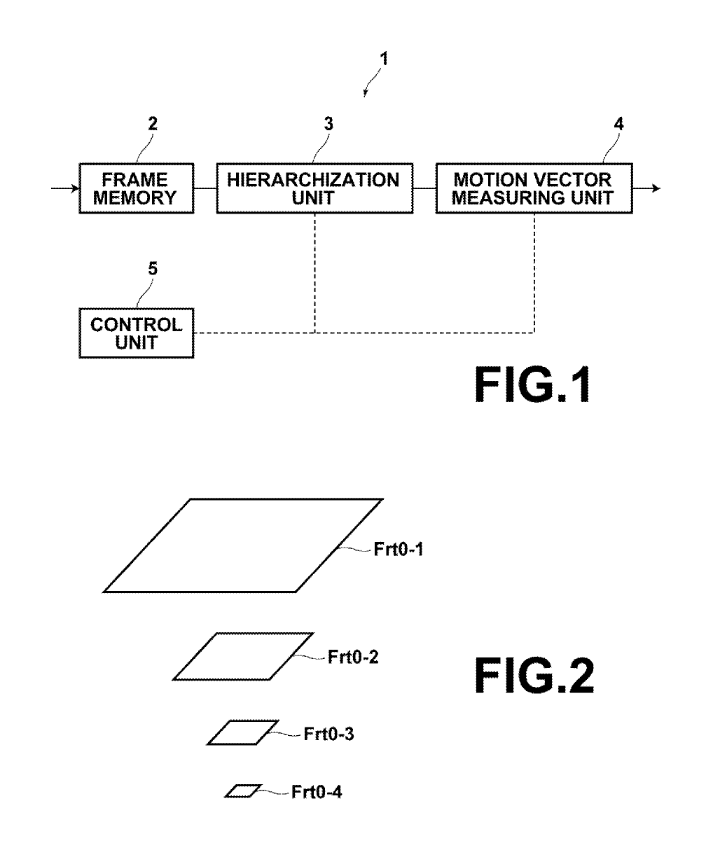

Hereinafter, embodiments of the present invention will be described with reference to the drawings. FIG. 1 is a schematic block diagram illustrating the configuration of a motion vector measurement device according to a first embodiment of the invention. As shown in FIG. 1, a motion vector measurement device 1 according to the first embodiment includes a frame memory 2, a hierarchization unit 3, a motion vector measuring unit 4 and a control unit 5.

The frame memory 2 temporarily stores image data of a digital moving image per frame, which is inputted from an image input device (not shown). A frame which is an object of motion vector measurement is herein referred to as an object frame Frt, and a frame previous to the object frame Frt used for the motion vector measurement is referred to as a previous frame Frt-i (i=1 to n, where n is a positive integer). A frame distance between the object frame Frt and the previous frame Frt-i may be set as appropriate depending on required accuracy of the motion vector measurement.

The hierarchization unit 3 hierarchizes each frame of the image data of the moving image temporarily stored in the frame memory 2 to generate hierarchy frames having lower resolutions. Since the frame memory 2 sequentially stores the frames of the image data of the moving image, the hierarchization unit 3 applies the hierarchization only once to each frame sequentially stored in the frame memory 2 to generate the low-resolution hierarchy frames. FIG. 2 is a diagram for explaining an operation carried out by the hierarchization unit 3. FIG. 2 shows the hierarchization of the object frame Frt. As shown in FIG. 2, the hierarchization unit 3 generates, for the highest resolution frame (which will hereinafter be referred to as a first hierarchy frame Frt0-1) not subjected to the hierarchization, a second hierarchy frame Frt0-2 having a resolution which is a half the resolution of the highest resolution frame (i.e., the second hierarchy frame Frt0-2 has a size which is a half the size of the first hierarchy frame Frt0-1 in the vertical and horizontal directions) using a known technique, such as thinning pixels or calculating a mean value of each block of four pixels. The hierarchization unit 3 further generates a third hierarchy frame Frt0-3 having a resolution which is a half the resolution of the second hierarchy frame Frt0-2. The hierarchization unit 3 further generates a fourth hierarchy frame Frt0-4 having a resolution which is a half the resolution of the third hierarchy frame Frt0-3.

When the motion vector is measured, as will be described later, the amount of operation is smaller when the resolution of the frame is lower, and the measurement can be carried out at a higher operation speed; however, the measurement accuracy becomes lower. Therefore, the number of hierarchy levels of the generated frames may be set as appropriate depending on required operation time and measurement accuracy.

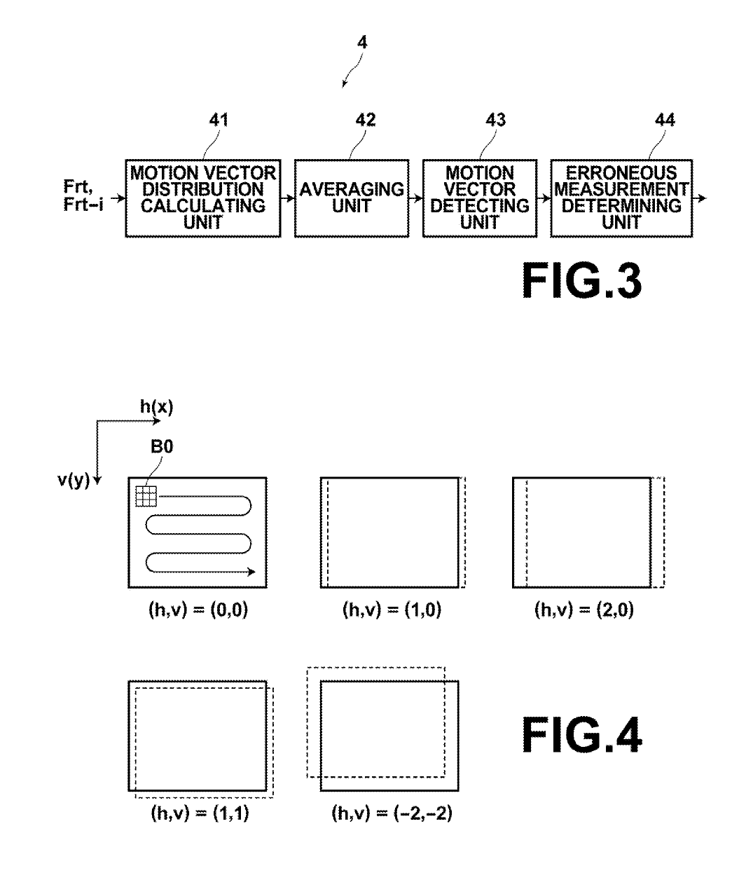

The motion vector measuring unit 4 measures a motion vector for each pixel position of the object frame Frt. Now, the measurement of the motion vector is described. The motion vector measuring unit 4 measures the motion vector with using the object frame and the previous frame at a high hierarchy level. However, in the following description, the object frame and the previous frame at the high hierarchy level are also denoted using the reference symbols Frt and Frt-i. FIG. 3 is a schematic block diagram illustrating the configuration of the motion vector measuring unit 4. As shown in FIG. 3, the motion vector measuring unit 4 includes a motion vector distribution calculating unit 41, an averaging unit 42, a motion vector detecting unit 43 and an erroneous measurement determining unit 44. Now, operations carried out by the motion vector distribution calculating unit 41, the averaging unit 42, the motion vector detecting unit 43 and the erroneous measurement determining unit 44 of the motion vector measuring unit 4 are described.

First, the motion vector distribution calculating unit 41 calculates a motion vector distribution between the object frame Frt and the previous frame Frt-i. FIG. 4 is a diagram for explaining calculation of the motion vector distribution. In FIG. 4, the object frame Frt is shown in the solid line and the previous frame Frt-i is shown in the dashed line. As shown in FIG. 4, the motion vector measuring unit 4 first aligns the object frame Frt with the previous frame Frt-i, and calculates a score C0, which indicates a correlation between the object frame Frt and the previous frame Frt, for each pixel position in the object frame Frt. Specifically, using a block B0 having a size of 3×3 pixels with an object pixel, for which the score is calculated, at the center of the block, a sum of absolute values of difference values between corresponding pixel values in the block B0 (a mean absolute error) is calculated as the score C0, with raster-scanning the block B0 on the object frame Frt and the previous frame Frt-i, as shown by Equation (1) below:

$$C 0 = {\sum }_{p = - 1}^{+ 1} {\sum }_{q = - 1}^{+ 1} \vert f ( x + p , y + q ) - g ( x + p , y + q ) \vert \qquad ( 1 )$$

The size of the block is not limited to 3×3 pixels; however, using a block as small as possible can reduce the amount of operation. In Equation (1), f(x+p,y+q) represents the pixel value in the object frame Frt and g(x+p,y+q) represents the pixel value in the previous frame Frt-i, where x and y represent the x-direction and the y-direction, respectively. Alternatively, a mean square error may be used as the score C0.

In order to prevent erroneous detection of the motion vector due to fluctuation of the exposure value and unexpected lightness change while the moving image is taken, mean values fm and gin of the pixel values of the object frame Frt and the previous frame Frt-i in the 3×3 block may be calculated, and a normalized score C0 may be calculated using the mean values fm and gm, as shown by Equation (2) below:

$$C 0 = {\sum }_{p = - 1}^{+ 1} {\sum }_{q = - 1}^{+ 1} \vert \{ f ( x + p , y + q ) - f m \} - \{ g ( x + p , y + q ) - g m \} \vert \qquad ( 2 )$$

The score C0 calculated according to the above Equation (1) or (2) becomes smaller when the correlation between the pixels is higher. In the following description of this embodiment, a score C1, which is calculated by subtracting the score C0 from the maximum value of pixel values of the inputted moving image, is used. In the case where the image is an 8-bit image, for example, the score C1 is calculated as follows: C1=255−C0. The score C1 becomes larger when the correlation between the pixels is higher.

Further, the motion vector distribution calculating unit 41 shifts the previous frame Frt-i relative to the object frame Frt pixel by pixel in a range of ±2 pixels in each of the horizontal direction and the vertical direction, and calculates the score C1 between the object frame Frt and the previous frame Frt-i for each pixel position in the object frame Frt each time the previous frame Frt-i is shifted. Assuming that a coordinate for shifting the previous frame Frt-i relative to the object frame Frt in the horizontal direction is h and a coordinate in the vertical direction is v, an amount of shift in pixel of the previous frame Frt-i relative to the object frame Frt is expresses as follows: (h,v)=(k,l) (where “k,l” is an integer in the range from −2 to +2). Specifically, when the object frame Frt and the previous frame Frt-i are aligned with each other, (h,v)=(0,0). When the previous frame Frt-i is shift by +1 pixel in the horizontal direction relative to the object frame Frt, (h,v)=(1,0). FIG. 4 shows amounts of shift of the previous frame Frt-i relative to the object frame Frt in the cases where (h,v)=(0,0), (1,0), (2,0), (1,1) and (−2,−2). The amounts of shift of the previous frame Frt-i relative to the object frame Frt shown in FIG. 4 are larger than actual amounts of shift for the convenience of explanation.

By calculating the score C1 each time the previous frame Frt-i is shifted relative to the object frame Frt pixel by pixel in the range of ±2 pixels in each of the horizontal direction and the vertical direction in this manner, a distribution of the scores C1, where the scores C1 calculated for each shift position are assigned to all the pixel positions in the object frame Frt, is calculated for each amount of shift. The scores C1 can be regarded as motion vectors in the object frame Frt when the previous frame Frt-i is shifted relative to the object frame Frt. Therefore, in this embodiment, the distribution of the scores C1 is referred to as a motion vector distribution D. Since there are 5×5=25 pixel shift patterns in this embodiment, 25 motion vector distributions D(k,l) (“k,l” is an integer in the range from −2 to +2) are calculated. In other words, 25 scores C1, i.e., the motion vectors, corresponding to the different shift positions are calculated for each pixel position in the object frame Frt.

The averaging unit 42 applies spatial averaging filtering to each motion vector distribution D(k,l) to remove noise from the motion vector distribution D(k,l) and calculate a mean motion vector distribution Dm(k,l). As the averaging filter, a filter having a size of 3×3 pixels may be used, for example. However, this is not intended to limit the invention, and the size of the averaging filter may be set as appropriate depending on a desired level of noise removal. Further, the filter to be used is not limited to the averaging filter and may be a spatial median filter.

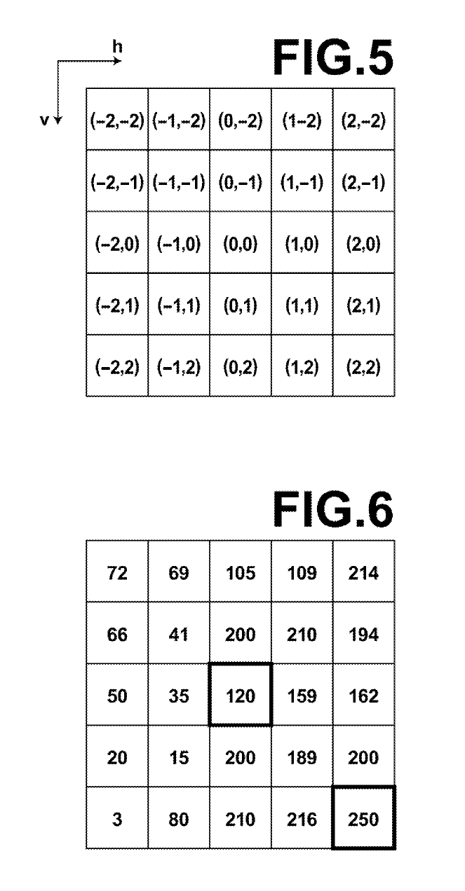

The motion vector detecting unit 43 detects the motion vector for each pixel position in the object frame Frt using the motion vector distributions Dm(k,l), each including 25 motion vectors. Now, detection of the motion vector is described. The motion vector detecting unit 43 sets a motion vector detection space for each pixel position in the object frame Frt and reconstructs the motion vectors in the motion vector detection space. FIGS. 5 and 6 are diagrams for explaining the reconstruction of the motion vector. In this embodiment, the previous frame Frt-i is shifted relative to the object frame Frt pixel by pixel in the range of ±2 pixels in each of the horizontal direction and the vertical direction to calculate the 25 scores C1, i.e., the motion vectors, for each pixel position in the object frame Frt. Therefore, as shown in FIG. 5, a motion vector detection space of 5×5=25 pixels is set for each object pixel position, which is the object of the motion vector detection. It should be noted that the positive and negative directions of the motion vector detection space are the same as the directions with respect to the amounts of pixel shift for calculating the motion vector distributions.

Then, the motion vector detecting unit 43 assigns, to 25 coordinate positions in the motion vector detection space of each pixel position, the scores C1 of a corresponding pixel position in the motion vector distributions Dm(k,l) calculated for the different amounts of pixel shift. That is, to the coordinate position (0,0) in the motion vector detection space of each object pixel position, the score C1 at the object pixel position in the motion vector distribution Dm(0,0) is assigned, and to the coordinate position (2,2) in the motion vector detection space of each object pixel position, the score C1 at the object pixel position in the motion vector distribution Dm(2,2) is assigned. In this manner, the scores C1, i.e., the motion vectors, are assigned to the motion vector detection space for each pixel position in the object frame Frt, as shown in FIG. 6, to reconstruct the motion vectors for each object pixel position.

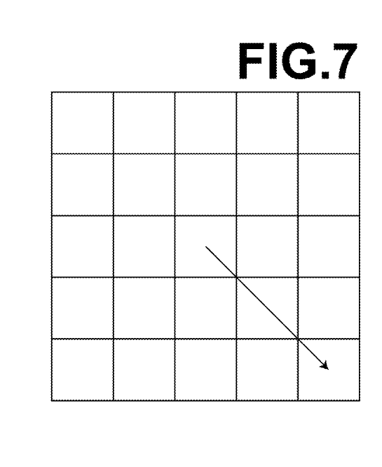

Subsequently, the motion vector detecting unit 43 detects a coordinate position with the maximum score C1 in the motion vector detection space for each object pixel position. It should be noted that, in the case where the scores C1 are calculated, a coordinate position with the maximum score C1 (which is hereinafter referred to as a “maximum coordinate position”) is detected, or in the case where the scores C0 are calculated, a coordinate position with the minimum score C0 is detected. Then, using the center coordinate position (i.e., the coordinate position (0,0)) in the motion vector detection space as a reference, a vector extending from the center coordinate position to the maximum coordinate position is detected as the motion vector for each object pixel position. For example, in the case where the motion vector is reconstructed as shown in FIG. 6, the maximum coordinate position is (2,2), and therefore a motion vector with the starting point of (0,0) and the end point of (2,2) is detected, as shown in FIG. 7. The magnitude of the motion vector is detected as a distance from the center coordinate position to the maximum coordinate position. For example, if the starting point of the motion vector is (0,0) and the end point is (2,2), the magnitude of the motion vector is 2√2.

It should be noted that the detected magnitude of the motion vector varies depending on the frame distance between the object frame Frt and the previous frame Frt-i. For example, if the frame distance between the object frame Frt and the previous frame Frt-i is 1, the detected magnitude of the motion vector can be used as the magnitude of the motion vector for the object pixel position without any conversion. If the frame distance is 2, the actual magnitude of the motion vector is a half the detected magnitude of the motion vector. If the frame distance is 3, the actual magnitude of the motion vector is a third the detected magnitude of the motion vector. Therefore, when the motion vector is detected, the motion vector detecting unit 43 modifies the magnitude of the motion vector depending on the frame distance between the object frame Frt and the previous frame Frt-i.

The motion vector detecting unit 43 carries out the above-described operation for all the pixel positions in the object frame Frt to detect the motion vectors for all the pixel positions in the object frame Frt. It should be noted that the motion vector distributions D(k,l) are calculated by calculating the scores C1 representing the motion vectors with shifting the previous frame Frt-i relative to the object frame Frt in the range of ±2 pixels in each of the horizontal direction and the vertical direction, and therefore, for pixel positions within two pixels from the edge the object frame Frt, it may be impossible to calculate the score C1. Therefore, the motion vectors are detected at pixel positions other than the pixel positions within two pixels from the edge the object frame Frt.

The erroneous measurement determining unit 44 determines whether or not the motion vector detected for each pixel position in the object frame Frt by the motion vector detecting unit 43 is erroneously measured. The starting point of each motion vector detected by the motion vector detecting unit 43 is the center coordinate position in the motion vector detection space, and the end point of each motion vector is a coordinate position with the maximum score C1 (or the minimum score C0) in the motion vector detection space. Since the 3×3 block used for calculating the motion vector distribution in this embodiment is smaller than a block, such as an 8×8 block, used in conventional block matching processes, a motion vector which accidentally appears due to noise in the frame may be detected. Further, in the case where a motion vector is detected for an object pixel position which does not correspond to a moving object but corresponds to the background of the object in the object frame Frt, the motion vector may appear in random directions. In such cases, a difference between a score C1s for the coordinate position of the starting point and a score C1e for the coordinate position of the end point of the detected motion vector is not so large.

Therefore, for each object pixel position, which is the object of the determination of erroneous measurement, in the object frame Frt, the erroneous measurement determining unit 44 determines that the detected motion vector is erroneously measured if a relationship between the score C1s for the coordinate position of the starting point and the score C1e for the coordinate position of the end point of the detected motion vector is C1s>C1e·α, and outputs a result of determination indicating that no motion vector has been measured for the object pixel position. On the other hand, if the relationship is C1s≦C1e·α, the erroneous measurement determining unit 44 determines that the detected motion vector is a true motion vector, and outputs the detected motion vector as a result of determination for the object pixel position. It should be noted that, with respect to the object pixel position for which the determination indicating that the motion vector is erroneously measured is made, a result of determination indicating that the motion vector is 0 may be outputted. The value of the coefficient α may be set depending on required measurement accuracy. The coefficient α may, for example, be a value such as 0.99, although this is not intended to limit the invention.

It should noted that the erroneous measurement determining unit 44 may determine that the detected motion vector is erroneously measured if the relationship between the score C1s for the coordinate position of the starting point and the score C1e for the coordinate position of the end point of the detected motion vector is C1e>C1s>C1e·α.

The control unit 5 controls operations of the hierarchization unit 3 and the motion vector measuring unit 4.

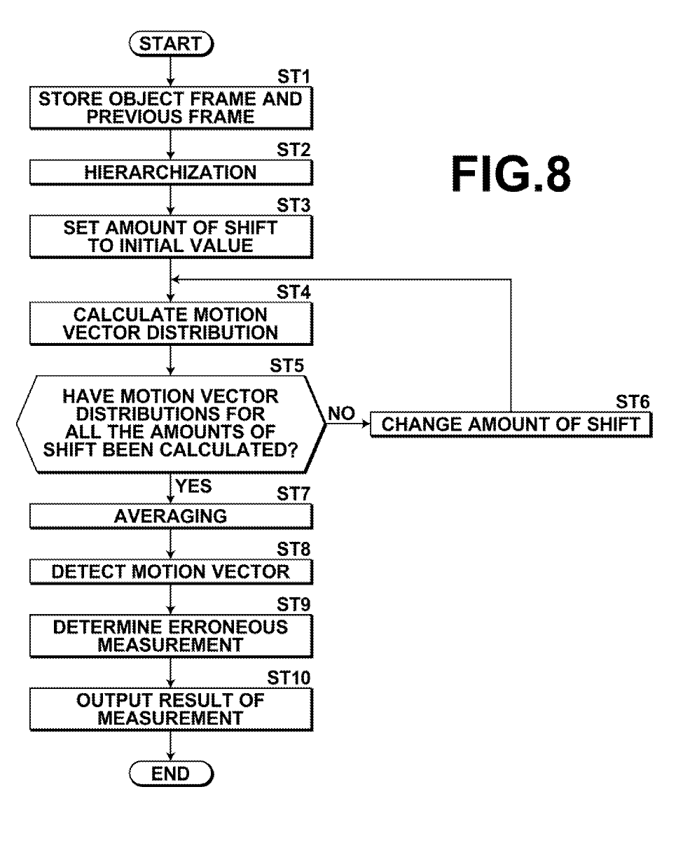

Next, operation of the first embodiment is described. FIG. 8 is a flow chart illustrating a process carried out in the first embodiment. When the object frame Frt and the previous frame Frt-i fed from an image input device (not shown) are stored in the frame memory 2 (step ST1), the hierarchization unit 3 hierarchizes the object frame Frt and the previous frame Frt-i (step ST2).

Then, the motion vector distribution calculating unit 41 of the motion vector measuring unit 4 sets the amount of shift of the object frame Frt and the previous frame Frt-i to an initial value (for example, (h,v)=(0,0)) (step ST3), and calculates the motion vector distribution D (step ST4). Then, determination is made as to whether or not the motion vector distributions for all the amounts of shift of the object frame Frt and the previous frame Frt-i have been calculated (step ST5). If a negative determination is made in step ST5, the amount of shift is changed (step ST6), and the process returns to step ST4. If an affirmative determination is made in step ST5, the averaging unit 42 averages the calculated motion vector distributions D (step ST7).

Subsequently, the motion vector detecting unit 43 detects the motion vector for each object pixel position (step ST8), and the erroneous measurement determining unit 44 determines whether or not the detected motion vector is erroneously measured (step ST9). Then, the motion vector measuring unit 4 outputs a result of measurement of the motion vector (step ST10), and the motion vector measurement process ends. It should be noted that, if it is determined that the motion vector is not erroneously measured, the measured motion vector is outputted. If it is determined that the motion vector is erroneously measured, a result of measurement indicating that no motion vector has been measured or a motion vector having a magnitude of 0 is outputted.

As described above, according to this embodiment, the motion vector at each object pixel position, which is the object of the motion vector detection, is detected based on values of the scores C1 in the motion vector distributions D, and determination is made as to whether or not the detected motion vector is erroneously measured based on the detected motion vector. Therefore, even using the block having a size as small as 3×3 pixels for measuring the motion vector using the block matching process, an erroneously measured motion vector can be determined, thereby achieving accurate measurement of the motion vector. Further, since use of a small block is allowed, the amount of operation can be reduced, thereby achieving high speed measurement of the motion vector.

Still further, by averaging the motion vector distributions D, noise removal from the motion vector distributions D is achieved, thereby achieving more accurate measurement of the motion vector.

Yet further, by hierarchizing the object frame Frt and the previous frame Frt-i, the amount of operation can be reduced, thereby achieving high speed measurement of the motion vector.

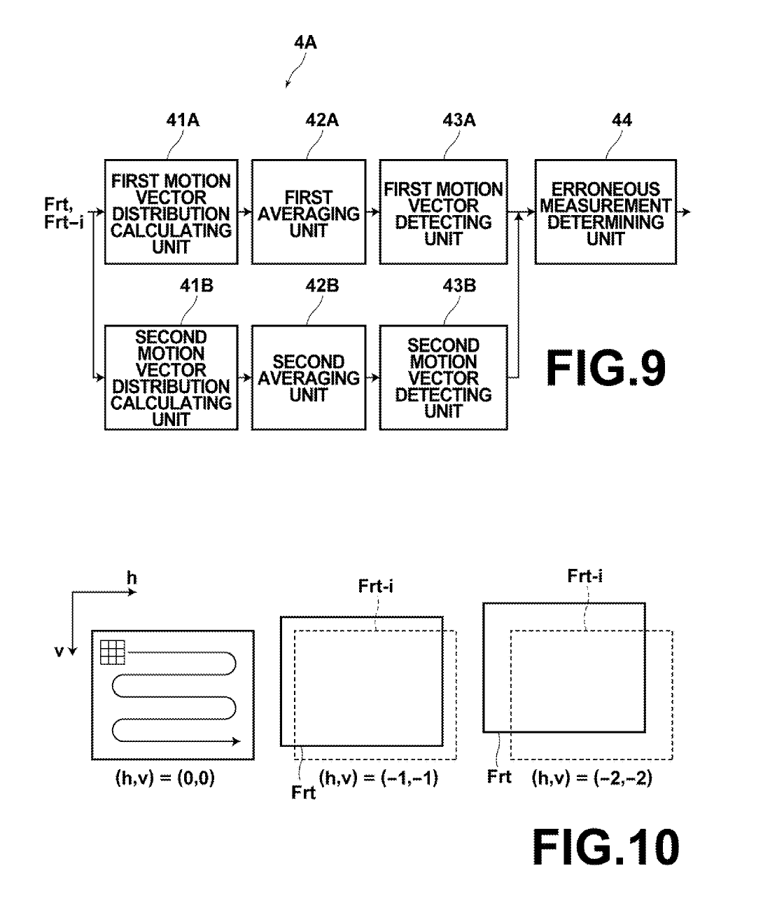

Next, a second embodiment of the invention is described. The difference between a motion vector measurement device according to the second embodiment of the invention and the motion vector measurement device according to the first embodiment lies only in the configuration of the motion vector measuring unit. Therefore, only the configuration of the motion vector measuring unit is described here. FIG. 9 is a schematic block diagram illustrating the configuration of the motion vector measuring unit of the second embodiment. Among the elements shown in FIG. 9, those which are the same as the configuration of the motion vector measuring unit 4 of the first embodiment are denoted by the same reference numerals, and detailed explanation thereof is omitted. A motion vector measuring unit 4A of the second embodiment includes a first motion vector distribution calculating unit 41A, a first averaging unit 42A and a first motion vector detecting unit 43A, which operate in the same manner as the motion vector distribution calculating unit 41, the averaging unit 42 and the motion vector detecting unit 43 of the first embodiment. The motion vector measuring unit 4A further includes a second motion vector distribution calculating unit 41B, a second averaging unit 42B and a second motion vector detecting unit 43B.

In the same manner as described in the first embodiment, the first motion vector distribution calculating unit 41A, the first averaging unit 42A and the first motion vector detecting unit 43A calculates the scores C1 representing the motion vectors with shifting the previous frame Frt-i relative to the object frame Frt to calculate the motion vector distributions D(k,l), average the motion vector distributions D(k,l), and detect the motion vectors. On the other hand, the second motion vector distribution calculating unit 41B, the second averaging unit 42B and the second motion vector detecting unit 43B calculate motion vector distributions with shifting the object frame Frt relative to the previous frame Frt-i, average the motion vector distributions, and detect the motion vectors.

Now, the case where the motion vectors are detected by calculating the scores C1 representing motion vectors with shifting the object frame Frt relative to the previous frame Frt-i to calculate the motion vector distributions D(k,l), and the case where the motion vectors are detected by calculating the motion vector distributions with shifting the object frame Frt relative to the previous frame Frt-i are considered. In the following description, the motion vectors detected with shifting the previous frame Frt-i relative to the object frame Frt is referred to as first motion vectors, and the motion vectors detected with shifting the object frame Frt relative to the previous frame Frt-i is referred to as second motion vectors, for the convenience of explanation. In this case, if the first and second motion vectors are not erroneously measured, the first and second motion vectors have the same magnitude, and directions of the first and second motion vectors are opposite from each other. In contrast, if the first and second motion vectors are erroneously measured, the first and second motion vectors have different magnitudes, or directions of the first and second motion vectors are not opposite from each other.

Therefore, in the second embodiment, the second motion vector distribution calculating unit 41B calculates the motion vector distributions with shifting the object frame Frt relative to the previous frame Frt-i, as shown in FIG. 10, the second averaging unit 42B averages the motion vector distributions, and the second motion vector detecting unit 43B detects the second motion vectors. Then, the erroneous measurement determining unit 44 determines pixel positions at the starting point and the end point of each of the first and second motion vectors at each object pixel position of the object frame Frt. If the starting point of the first motion vector and the end point of the second motion vector are the same, and the end point of the first motion vector and the starting point of the second motion vector are the same, the erroneous measurement determining unit 44 determines that the first motion vector is a true motion vector. Otherwise, the erroneous measurement determining unit 44 determines that the first motion vector is erroneously measured. In this manner, determination of the erroneous measurement of the motion vector can be achieved, as with the first embodiment.

It should be noted that movement of an object observed between the object frame Frt and the previous frame Frt-i is not necessarily in pixels, and may be in a unit smaller than one pixel. For example, a moving object contained in the previous frame Frt-i may be shifted in the object frame Frt by 1.5 pixels, i.e., may move in subpixels, from the position in the previous frame Frt-i. In this case, even when a certain object pixel position corresponds to a true moving object, pixel positions of the starting point and the end point of the second motion vector measured for the object pixel position are not completely the same as pixel positions of the end point and the starting point of the first motion vector. Therefore, when the determination of erroneous measurement is made using the first and second motion vectors in the second embodiment, a determination that the second motion vector has the same magnitude as the magnitude of the first motion vector may be made if a difference between the coordinate position of the end point of the second motion vector and the coordinate position of the starting point of the first motion vector is within ±1 pixel in the horizontal and vertical directions. This can reduce possibility of a true motion vector being determined as erroneously measured.

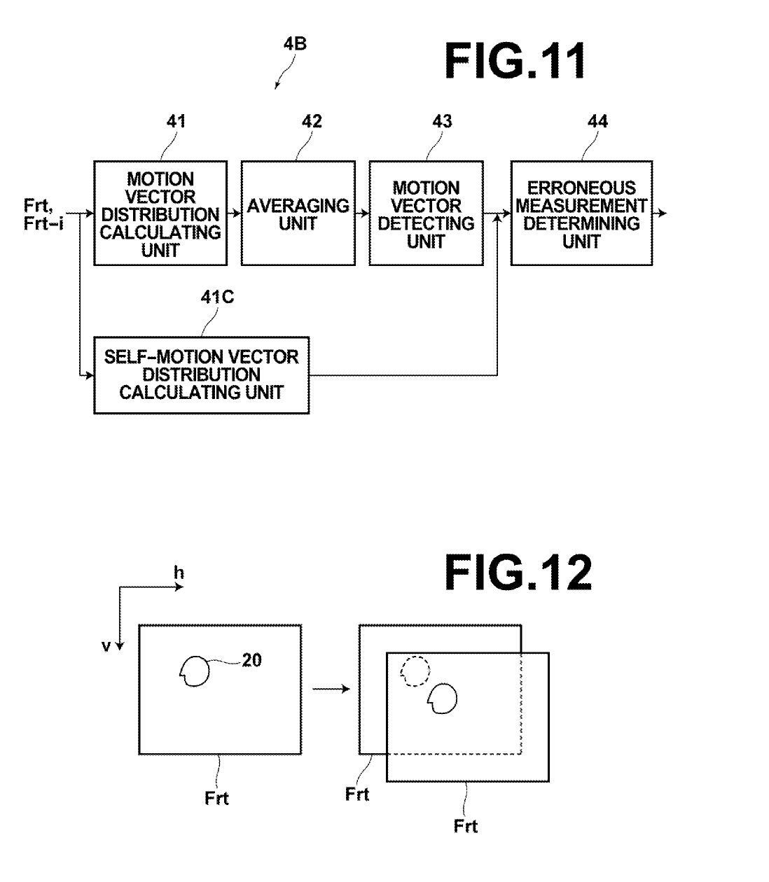

Next, a third embodiment of the invention is described. Similarly to the second embodiment, the difference between a motion vector measurement device according to the third embodiment of the invention and the motion vector measurement device according to the first embodiment lies only in the configuration of the motion vector measuring unit. Therefore, only the configuration of the motion vector measuring unit is described here. FIG. 11 is a schematic block diagram illustrating the configuration of the motion vector measuring unit of the third embodiment. Among the elements shown in FIG. 11, those which are the same as the configuration of the motion vector measuring unit 4 of the first embodiment are denoted by the same reference numerals, and detailed explanation thereof is omitted. A motion vector measuring unit 4B of the third embodiment differs from the first embodiment in that the motion vector measuring unit 4B includes a self-motion vector distribution calculating unit 41C, which calculates motion vector distributions by calculating scores which have a higher value when the correlation is larger, similarly to the above-described first embodiment, with shifting a duplication of the object frame Frt relative to the object frame Frt. The motion vector distribution calculated by the self-motion vector distribution calculating unit 41C is referred to as a self-motion vector distribution. The scores of the self-motion vector distribution are referred to as scores C1′.

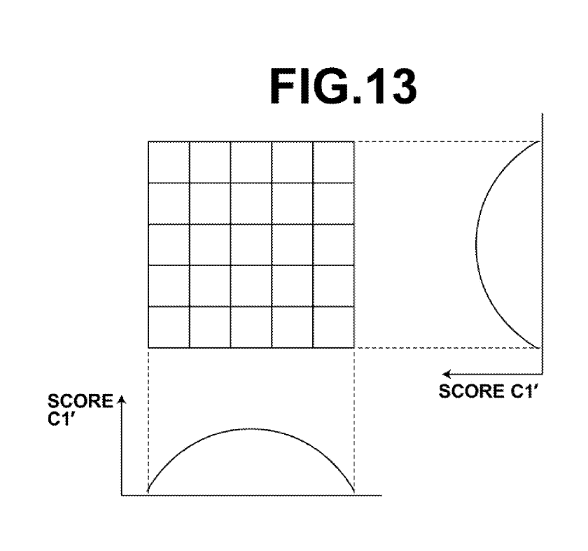

In the case where a moving object 20 is contained in the object frame Frt, as shown in FIG. 12, when overlapping object frames Frt are shifted relative to each other, the position of the object 20 is naturally shifted. Therefore, when 25 self-motion vector distributions are calculated in the same manner as described above and the scores C1′ at each corresponding pixel position of the self-motion vector distributions are assigned to the motion vector detection space of each object pixel position corresponding to the object 20, as shown in FIG. 13, the score C1′ at the center coordinate position (0,0) becomes large, and the scores C1′ at other coordinate positions become smaller as the distance between the coordinate position and the center coordinate position (0,0) becomes larger.

In contrast, when the scores C1′ at each corresponding pixel position of the self-motion vector distributions are assigned to a motion vector detection space of each object pixel position corresponding to a monotonous background of the object 20, pixel values at pixel positions around the object pixel position do not largely differ from pixel value at the object pixel position, and therefore the scores C1′ are relatively large regardless of the coordinate positions in the motion vector detection space.

The fact that the score C1′ at a coordinate position in the self-motion vector distribution other than the center coordinate position (0,0) becomes large means that it is highly possible that erroneous measurement occurs at the coordinate position with the large score. Therefore, whether or not a detected motion vector is erroneously measured can be determined depending on the value of the score C1′ at a position corresponding to the endpoint position of the detected motion vector in the self-motion vector distribution.

In the third embodiment, the self-motion vector distribution calculating unit 41C calculates the self-motion vector distributions, assigns the scores C1′ at each corresponding position of the self-motion vector distributions to the motion vector detection space of each object pixel position, and measures the score C1′ of the self-motion vector distribution at the coordinate position in the motion vector detection space corresponding to the end point of the motion vector for the object pixel position. Then, the erroneous measurement determining unit 44 compares the measured score C1′ with a predetermined threshold value Th1. If the score C1′ is smaller than the threshold value Th1, the erroneous measurement determining unit 44 determines that the motion vector is a true motion vector. If the score C1′ is not smaller than the threshold value Th1, the erroneous measurement determining unit 44 determines that the motion vector is erroneously measured. In this manner, the determination of erroneous measurement of the motion vector can be achieved, as with the first embodiment.

It should be noted that the erroneous measurement determining unit 44 may determine whether or not the motion vector is a true motion vector with using a classifier, which determines whether or not the motion vector is a true motion vector, generated through a machine learning process. In this case, the classifier may be generated by carrying out a learning process using score distributions of motion vector detection spaces where motion vectors are true motion vectors as positive teacher data, and score distributions of motion vector detection spaces where motion vectors are erroneously detected as negative teacher data.

In the above-described first to third embodiments, the hierarchization unit 3 hierarchizes the object frame Frt and the previous frame Frt-i to measure the motion vectors using the frames at a high hierarchy level. However, the object frame Frt and the previous frame Frt-i may not be hierarchized, and the motion vectors may be measured using the object frame Frt and the previous frame Frt-i without any conversion.

Further, in the above-described first to third embodiments, the motion vector at each object pixel position in the object frame Frt may be determined based on motion vectors at pixel positions in the neighborhood of the object pixel position. For example, a mean value of the motion vectors at the pixel positions in the neighborhood of the object pixel position may be used as the motion vector at the object pixel position. With this, variation of the motion vectors can be reduced to achieve more accurate measurement of the motion vector at each object pixel position.

Still further, in the above-described first to third embodiments, the amounts of shift between the object frame Frt and the previous frame Frt-i for measuring the motion vectors are within the range of ±2 pixels in each of the horizontal direction and the vertical direction. However, this is not intended to limit the invention, and the range of the amounts of shift may be set as appropriate, such as in the range of ±1 pixel or in the range of ±3 pixels, depending on required measurement accuracy.

Yet further, although the motion vector distributions D are averaged in the above-described first to third embodiments, the motion vectors may be measured without averaging the motion vector distributions D.

The device 1 according to the embodiments of the invention has been described. The invention may also be implemented in the form of a program for causing a computer to function as means corresponding to the hierarchization unit 3, the motion vector measuring unit 4 and the control unit 5 described above, to carry out the operation as shown in FIG. 8. The invention may also be implemented in the form of a computer-readable recording medium containing such a program.

What is claimed is:

1. A motion vector measurement device for measuring a motion vector at an object pixel position in an object frame among a plurality of frames contained in a moving image based on the object frame and a previous frame apart from the object frame by a predetermined frame distance in the moving image, the device comprising:
motion vector distribution calculating means for calculating, for each object pixel to be an object of the motion vector measurement in the object frame, a motion vector distribution in a motion vector detection space defined by a predetermined number of pixels by calculating scores, each representing a correlation between the object pixel and a corresponding pixel in the previous frame corresponding to the object pixel, with shifting the previous frame relative to the object frame in a range of the predetermined number of pixels;
motion vector detecting means for detecting a motion vector at the object pixel based on differences between the score at a center position in the motion vector detection space for the motion vector distribution and the scores at positions other than the center position in the motion vector detection space; and
erroneous measurement determining means for determining whether or not the motion vector is erroneously measured based on the motion vector distribution.

2. The motion vector measurement device as claimed in claim 1, further comprising averaging means for averaging the motion vector distribution.

3. The motion vector measurement device as claimed in claim 1, wherein the motion vector distribution calculating means calculates the scores being normalized based on pixel values of pixels in a block having a predetermined size with the object pixel at a center of the block.

4. The motion vector measurement device as claimed in claim 1, wherein the erroneous measurement determining means determines that the motion vector is erroneously measured if a difference between the score at a starting point position and the score at an end point position of the motion vector in the motion vector detection space is smaller than a predetermined threshold value.

5. The motion vector measurement device as claimed in claim 1, further comprising:
second motion vector distribution calculating means for calculating, for each object pixel, a second motion vector distribution in the motion vector detection space by calculating scores, each representing a correlation between the object pixel and a corresponding pixel in the previous frame corresponding to the object pixel, with shifting the object frame relative to the previous frame in the range of the predetermined number of pixels; and
second motion vector detecting means for detecting a second motion vector at the object pixel based on differences between the score at a center position in the motion vector detection space for the second motion vector distribution and the scores at positions other than the center position in the motion vector detection space for the second motion vector distribution,
wherein the erroneous measurement determining means determines that the motion vector is not erroneously measured if the motion vector and the second motion vector have the same magnitude and directions of the motion vector and the second motion vector are opposite from each other.

6. The motion vector measurement device as claimed in claim 1, further comprising:
self-motion vector distribution calculating means for calculating, for each object pixel, a self-motion vector distribution in the motion vector detection space by calculating, with shifting a duplication of the object frame relative to the object frame in the range of the predetermined number of pixels, scores each representing a correlation between the object pixel and a corresponding pixel in the duplication of the object frame corresponding to the object pixel,
wherein, in a case where the score is larger when the correlation is higher, the erroneous measurement determining means compares the score in the motion vector detection space for the self-motion vector distribution at a position corresponding to the end point position of the motion vector in the motion vector detection space with a predetermined threshold value, and determines that the motion vector is erroneously measured if the score is not smaller than the predetermined threshold value.

7. The motion vector measurement device as claimed in claim 1, wherein the erroneous measurement determining means determines whether or not the motion vector is erroneously measured with using a classifier generated through a machine learning process for determining whether or not the motion vector is a true motion vector.

8. A motion vector measurement method of measuring a motion vector at an object pixel position in an object frame among a plurality of frames contained in a moving image based on the object frame and a previous frame apart from the object frame by a predetermined frame distance in the moving image, the method comprising:
calculating, for each object pixel to be an object of the motion vector measurement in the object frame, a motion vector distribution in a motion vector detection space defined by a predetermined number of pixels by calculating scores, each representing a correlation between the object pixel and a corresponding pixel in the previous frame corresponding to the object pixel, with shifting the previous frame relative to the object frame in a range of the predetermined number of pixels;
detecting a motion vector at the object pixel based on differences between the score at a center position in the motion vector detection space for the motion vector distribution and the scores at positions other than the center position in the motion vector detection space; and
determining whether or not the motion vector is erroneously measured based on the motion vector distribution.

9. A computer-readable recording media containing a program for causing a computer to carry out a motion vector measurement method of measuring a motion vector at an object pixel position in an object frame among a plurality of frames contained in a moving image based on the object frame and a previous frame apart from the object frame by a predetermined frame distance in the moving image, the program causing the computer to carry out the steps of:
calculating, for each object pixel to be an object of the motion vector measurement in the object frame, a motion vector distribution in a motion vector detection space defined by a predetermined number of pixels by calculating scores, each representing a correlation between the object pixel and a corresponding pixel in the previous frame corresponding to the object pixel, with shifting the previous frame relative to the object frame in a range of the predetermined number of pixels;
detecting a motion vector at the object pixel based on differences between the score at a center position in the motion vector detection space for the motion vector distribution and the scores at positions other than the center position in the motion vector detection space; and
determining whether or not the motion vector is erroneously measured based on the motion vector distribution.
